(19) United States
(12) Patent Application Publication
(10) Pub. No.: US 2008/0266604 A1
(43) Pub. Date: Oct. 30, 2008

(54) IMAGE FORMING APPARATUS, PRINTING METHOD AND CONTROL PROGRAM

(75) Inventors: Jun KUROKI, Sagamihara-shi (JP); Yoko FUJIWARA, Kawasaki-shi (JP); Yoshinori TANAKA, Shibuya-ku (JP); Masahiro OZAWA, Hino-shi (JP); Hiroshi NOGAWA, Hachioji-shi (JP); Fumihito AKIYAMA, Yokohama-shi (JP); Yasufumi AOYAMA, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/867,641

(22) Filed: Oct. 4, 2007

(30) Foreign Application Priority Data
Dec. 19, 2006 (JP) 2006-340693

(51) Int. Cl. G06K 15/00; H04N 1/387

(52) U.S. Cl. 358/1.16; 358/453

(57) ABSTRACT

There is described an image forming apparatus, which makes it possible to implement a high-speed printing operation based on print data attached with a digital signature. The apparatus comprises: a storage section to store print data; a, digital signature analyzing section to analyze a digital signature; a language analyzing section to analyze the print data; an image processing section to create bitmap data; a printing section to implement a printing operation; and a control section that selectively conducts either a first controlling operation or a second controlling operation. In the first controlling operation, the digital signature analyzing section and the language analyzing section respectively conduct the digital signature analyzing operation and the language analyzing operation in parallel, while, in the second controlling operation, the digital signature analyzing section conducts the digital signature analyzing operation at first, and the language analyzing section conduct the language analyzing operation after the digital signature analyzing operation is completed.

This application is based on Japanese Patent Application No. 2006-340693 filed on Dec. 19, 2006 with Japan Patent Office, the entire content of which is hereby incorporated by reference.

### BACKGROUND OF THE INVENTION

The present invention relates to an image forming apparatus, a printing method and a control program, and specifically relates to an image forming apparatus, a printing method and a control program, each of which prints a document created on the basis of the XML, Paper Specification (hereinafter, also referred to as the XPS).

In recent years, there have been increasingly proliferated in the market various kinds of copiers or multi-functional apparatuses, each provided with a combination of plural functions, such as a copy function, a facsimile function, a printer function, a scanner function, etc., (hereinafter, referred to as an image forming apparatus as a general term for each of them). When the image forming apparatus is employed as the network printer to implement the printing operation, at first, the concerned document is created by using the application program installed in advance in the computer terminal device coupled to the network, and then, the created document is converted to the print data in the format of the Page Description Language (hereinafter, also referred to as the PDL, for simplicity), so as to be transmitted the print data to the image forming apparatus concerned. Receiving the print data from the computer terminal device, the image forming apparatus parses the print data to create intermediate data, and then, further converts the intermediate data to bitmap data, so as to output an image based on the bitmap data onto a paper medium.

On that occasion, since there is a fear that the print data to be transmitted through the network might be possibly falsified during the transmitting operation of the print data, the method for judging validity of the print data by employing a digital signature has been usually employed. For instance, Japanese Non-Examined Patent Publication No. 2005-267022, sets forth a method in which: the digital signature and the electronic certificate attached to the document data concerned are used to decrypt the digital signature by employing the public key included in the electronic certificate to acquire hash values; the hash values inherent to the document data are compared with the hash values acquired; the document data is determined not to be falsified if the hash values inherent to the document data coincide with those acquired; document data including hidden character information is created to output to the printer concerned; and thus the printer prints an image represented by the document data including the hidden character information.

In this connection, there have existed as the printing methods: the normal printing method; and the other method (hereinafter, referred to as the direct printing method). In the normal printing method, the print data is transmitted to an image forming apparatus through the printer driver equipped in the computer terminal device, and the print data is parsed by employing the print controller provided in the image forming apparatus concerned, and then the printing section implements the printing operation. On the other hand, in the direct printing method, the print data is directly transmitted to an image forming apparatus without employing the printer driver; and the print data is parsed by employing the print controller provided in the image forming apparatus concerned, and then the printing section implements the printing operation. When the direct printing method is employed for printing an image represented by the print data with the digital signature, there has been a problem that the processing speed considerably decreases, since the print data should be stored once into an HDD (Hard Disc Drive), etc., and then, should be read twice from the HDD, etc., for analyzing the digital signature and for parsing the print data.

### SUMMARY OF THE INVENTION

To overcome the abovementioned drawbacks in conventional image forming apparatus, it is one of objects of the present invention to provide an image forming apparatus, a printing method and a control program thereof, which makes it possible to implement a high-speed printing operation based on print data attached with a digital signature.

Accordingly, at least one of the objects of the present invention can be attained by the image-recording apparatus described as follows.

(1) According to an image forming apparatus reflecting an aspect of the present invention, the image forming apparatus, comprises: a storage section to store print data acquired from an external environment in it; a digital signature analyzing section that conducts a digital signature analyzing operation to analyze a digital signature included in the print data; a language analyzing section that conducts a language analyzing operation to analyze the print data so as to create intermediate data; an image processing section to create bitmap data from the intermediate data created by the language analyzing section; a printing section to implement a printing operation based on the bitmap data created by the image processing section; and a control section that selectively conducts either a first controlling operation or a second controlling operation. In the first controlling operation the control section makes the digital signature analyzing section and the language analyzing section respectively conduct the digital signature analyzing operation and the language analyzing operation in parallel, while in the second controlling operation the control section makes the digital signature analyzing section conduct the digital signature analyzing operation at first, and makes the language analyzing section conduct the language analyzing operation after the digital signature analyzing operation is completed.

(2) According to another aspect of the present invention, in the image forming apparatus recited in item 1, in the first controlling operation, the control section reads out the print data from the storage section and notifies both the digital signature analyzing section and the language analyzing section of existence of the print data, while, in the second controlling operation, the control section reads out the print data from the storage section and notifies the digital signature analyzing section of the existence of the print data at first, and again reads out the print data from the storage section, and notifies the language analyzing section of existence of the print data after the digital signature analyzing operation is completed.

(3) According to still another aspect of the present invention, in the image forming apparatus recited in item 1, the control section conducts the first controlling operation when a first printing mode, in which the printing operation should be conducted irrespective of validity of the digital signature, is established, while the control section conducts the second controlling operation when a second printing mode, in which the printing operation should be conducted only when the digital signature is determined as valid, is established.

(4) According to still another aspect of the present invention, in the image forming apparatus recited in item 1, when the digital signature is attached to the print data, the control section conducts any one of the first controlling operation and the second controlling operation.

(5) According to yet another aspect of the present invention, in the image forming apparatus recited in item 1, the print data are created, based on an XPS (XML Paper Specification).

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram of a configuration of a printing system embodied in the present invention as the first embodiment;

FIG. 2 shows a block diagram indicating a configuration of a computer terminal device embodied in the present invention as the first embodiment;

FIG. 3 shows a block diagram indicating a configuration of an image forming apparatus embodied in the present invention as the first embodiment;

FIG. 4 shows a chart for comparing a normal printing mode and a direct printing mode with each other;

FIG. 5 shows a structure of the XPS data without a digital signature;

FIG. 6 shows a flowchart of a direct printing procedure of the XPS data without a digital signature;

FIG. 7 shows a structure of the XPS data with a digital signature;

FIG. 8 shows an extracted part of the whole specification of the XPS;

FIG. 9 shows a flowchart of direct printing procedures of the XPS data with a digital signature, which are to be conducted in a “Print Invalid Signature” mode;

FIG. 10 shows a flowchart of direct printing procedures of the XPS data with a digital signature, which are to be conducted in a “Print Invalid Signature With Error Report” mode;

FIG. 11 shows a flowchart of direct printing procedures of the XPS data with a digital signature, which are to be conducted in a “Print Only Valid Signature” mode;

FIG. 12 shows an explanatory schematic diagram for explaining effects of the present invention; and

FIG. 13 shows a flowchart of printing procedures to be employed in a printing system embodied in the present invention.

### DETAILED DESCRIPTION OF THE PREFERRED EMBODIMENT

The well-known as an application program for creating a document is such the application program that is operated on the basis of a standard called the XPS for describing the document in the form of the XML, (Extensible Markup Language). It is possible to attach the digital signature to the data created on the basis of the XPS (hereinafter, referred to as the XPS data), and it is also possible for the image forming apparatus complying with the XPS format to implement the direct printing operation based on the XPS data, as well as the PDF (Portable Document Format) data.

As described in the “BACKGROUND OF THE INVENTION”, however, when the direct printing operation is conducted to print an image represented by the XPS data with the digital signature, the print data should be stored once into the storage section, such as the HDD, etc., for the purpose of print spooling, and then, it is necessary to read the print data from the storage section twice, namely, at the time when analyzing the digital signature and at the other time when analyzing the print job. Accordingly, there has been a problem that the processing speed considerably decreases to a lower level.

On the other hand, the XPS allows the image forming apparatus to conduct the printing operation in a specific printing mode selected from various kinds of printing modes depending on the validity of the digital signature. Further, in a certain specific printing mode, it is also possible to commence the job analyzing operation without taking the analyzing result of the digital signature into account. Accordingly, in the present invention, by making it possible to select either a processing mode in which the processing for analyzing the digital signature and the processing for analyzing the print job are simultaneously implemented, or another processing mode in which the processing for analyzing the print job is implemented after the processing for analyzing the digital signature is completed, corresponding to the printing mode, the number of operations for reading the print data from the storage section is reduced, so as to make it possible to implement the printing operation at a high speed.

### <EMBODIMENT>

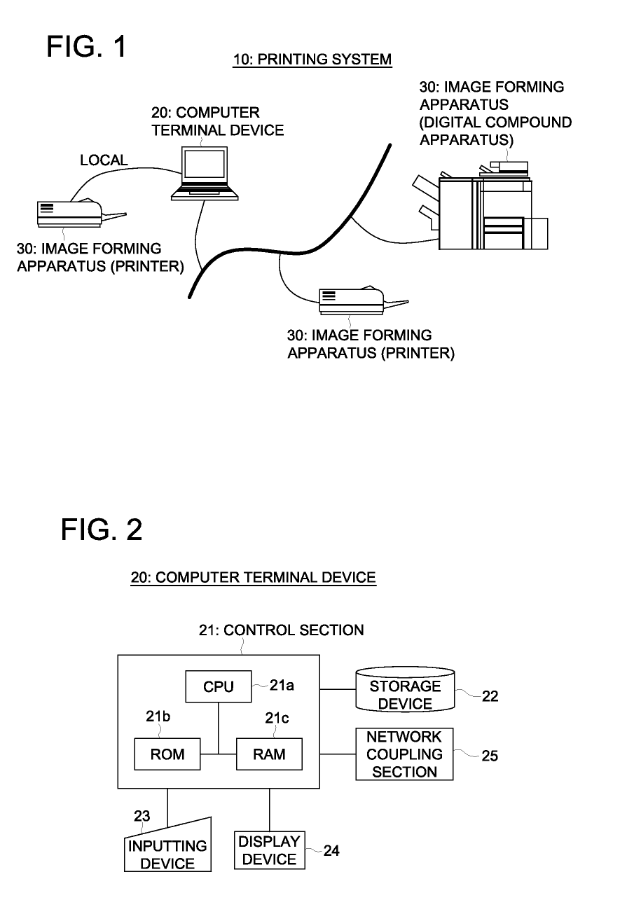

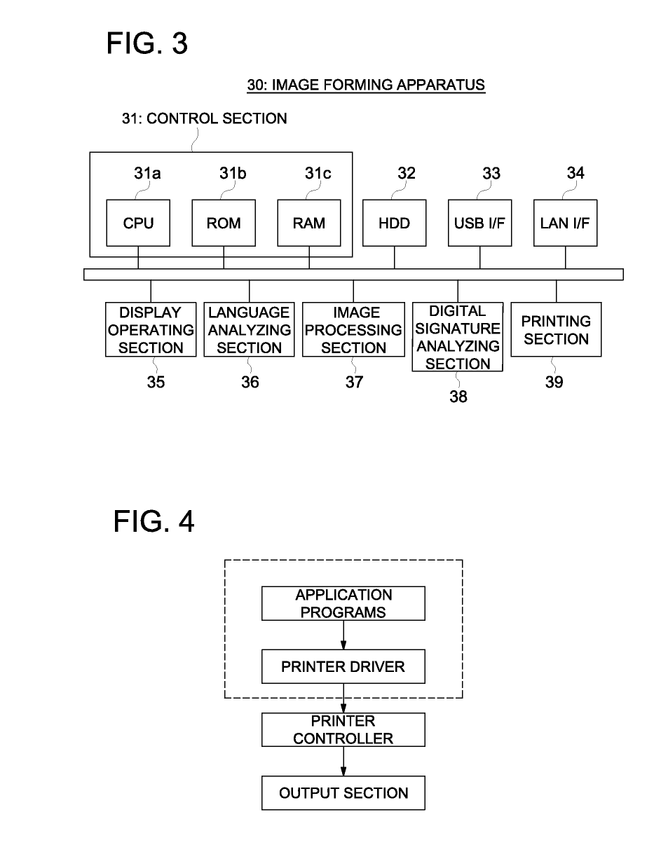

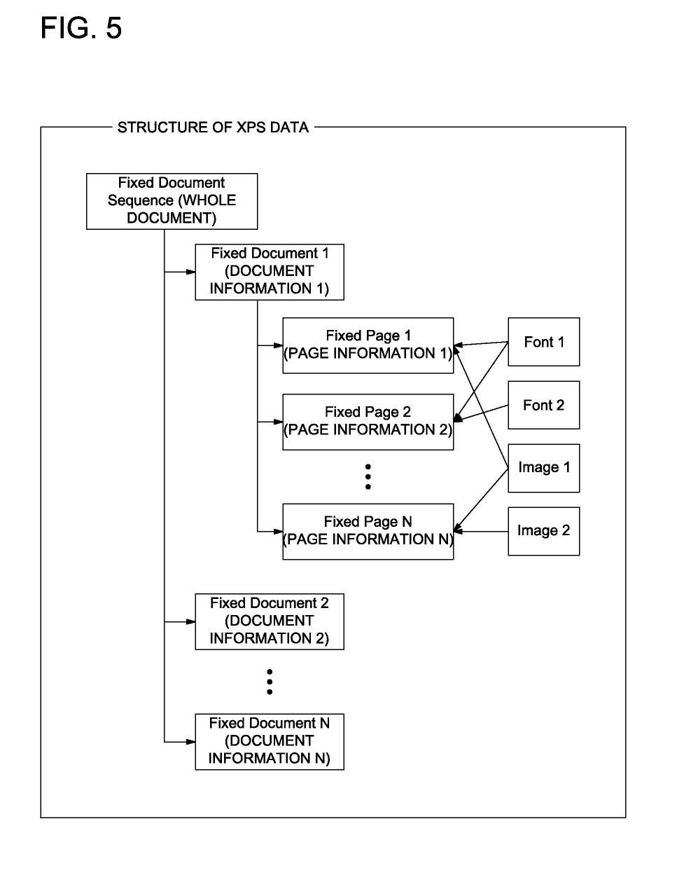

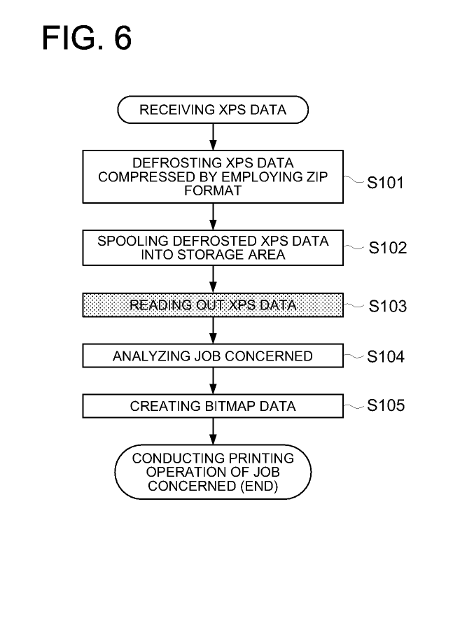

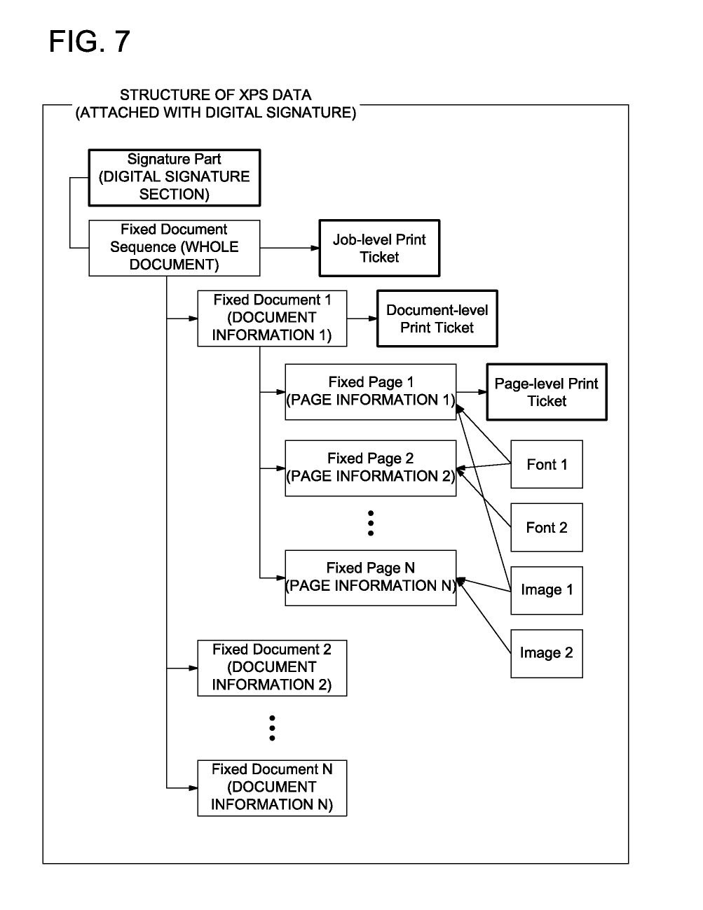

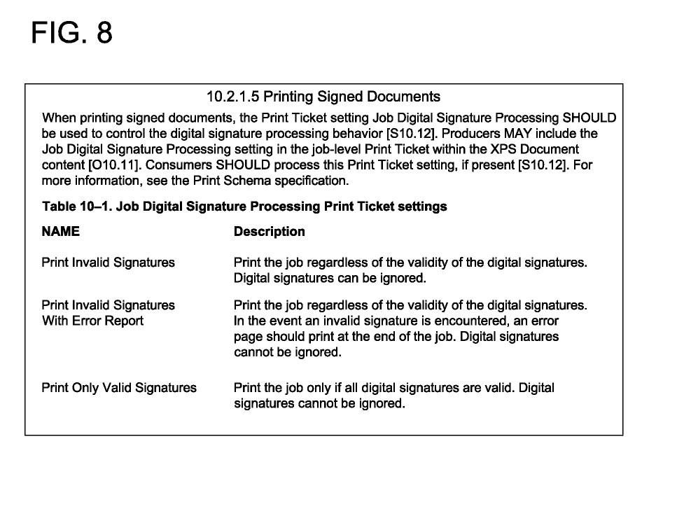

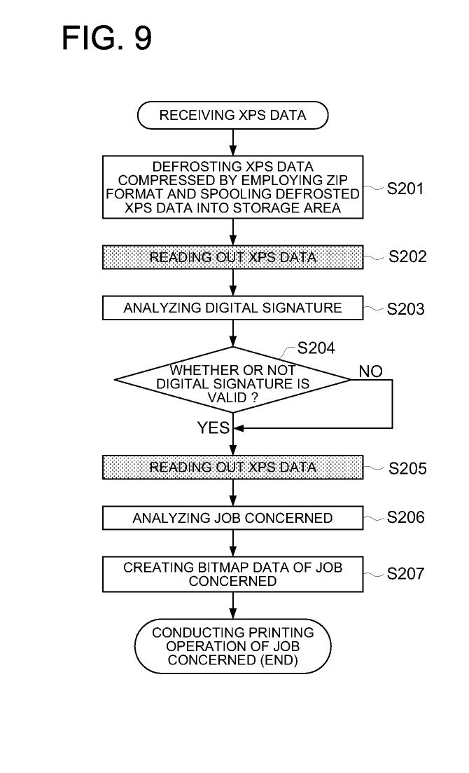

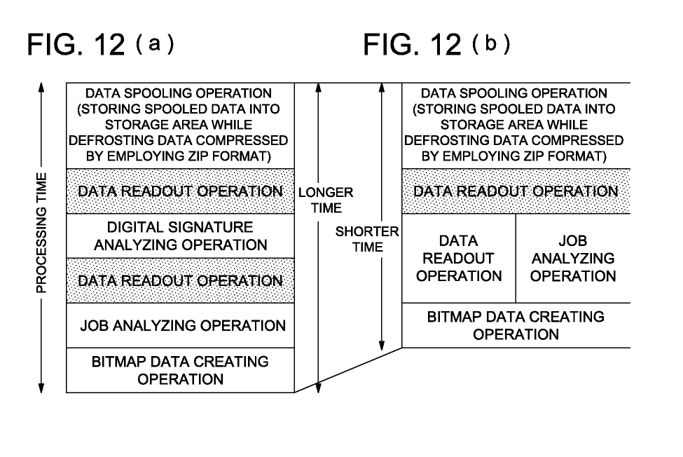

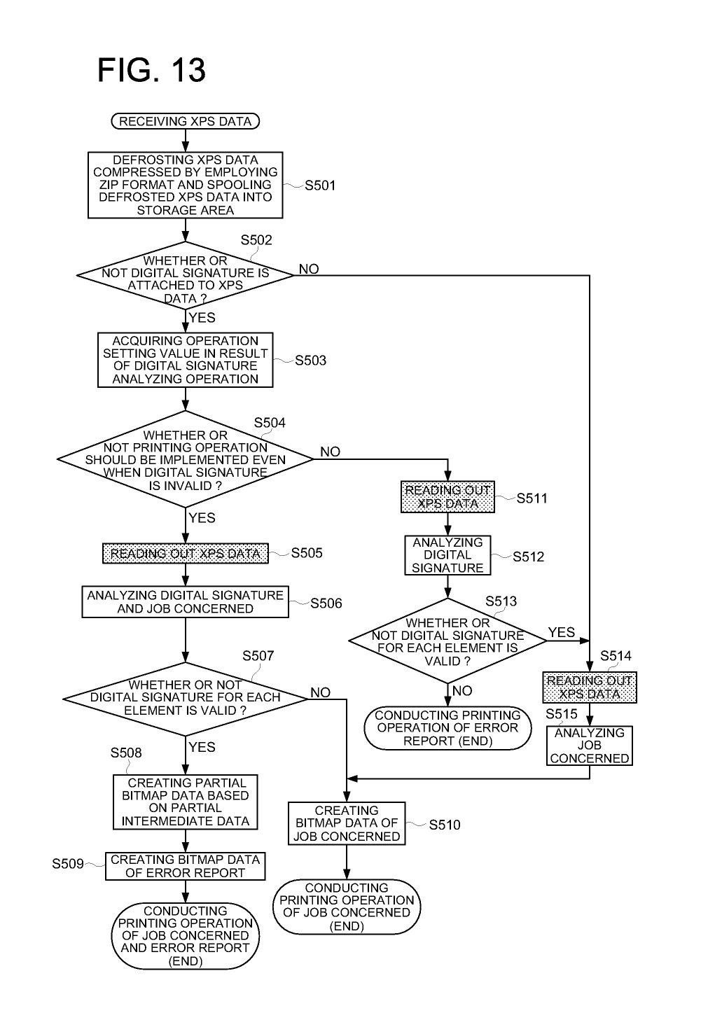

In order to describe the preferred embodiment of the present invention in detail, referring to FIG. 1 through FIG. 13, an image forming apparatus and a printing method and a control program, embodied in the present invention, will be detailed in the following. FIG. 1 shows a schematic diagram of a configuration of the printing system embodied in the present invention, FIG. 2 shows a block diagram indicating a configuration of the computer terminal device, and FIG. 3 shows a block diagram indicating a configuration of the image forming apparatus. Further, FIG. 4 shows a chart for comparing the normal printing mode and the direct printing mode with each other. Still further, FIG. 5 shows a structure of the XPS data without the digital signature, and FIG. 6 shows a flowchart of the direct printing procedure of the XPS data without the digital signature. Still further, FIG. 7 shows a structure of the XPS data with the digital signature, FIG. 8 shows an extracted part of the whole specification of the XPS, and FIGS. 9 - 11 show flowcharts of the direct printing procedures of the XPS data with the digital signature. Yet further, FIG. 12 shows an explanatory schematic diagram for explaining the effects of the present invention, while FIG. 13 shows a flowchart of the printing procedures to be employed in the printing system embodied in the present invention.

As shown in FIG. 1, the printing system 10, embodied in the present invention, is constituted by a computer terminal device 20 in which an application program for creating a document based on a standard conformity with the XPS, etc., is installed in advance, so as to create the document by executing the application program, and an image forming apparatus 30, such as a printer, a digital multi-function peripheral (MFP), which acquires the print data described in the Page Description Language from the computer terminal device 20, so as to print the document based on the print data acquired. The computer terminal device 20 and the image forming apparatus 30 are coupled to each other through a communication network, such as a LAN (Local Area Network), a WAN (Wide Area Network), etc. In this connection, it is needless to say that a plurality of computer terminal devices, each of which serves as the computer terminal device 20 abovementioned, and/or a plurality of image forming apparatuses, each of which serves as the computer terminal device 20 abovementioned, can be coupled to the communication network, so as to constitute the printing system 10.

Further, as shown in FIG. 2, the computer terminal device 20 is provided with a control section 21 including a CPU (Central Processing Unit) 21a, a ROM (Read Only Memory) 21b, a RAM (Random Access Memory) 21c, etc.; a storage device 22, such as a Hard Disc Drive, etc., to store various kinds of programs and data; an inputting device 23, such as a keyboard, etc., to be operated for inputting data so as to implement a document creating operation, etc.; a display device 24, such as an LCD (Liquid Crystal Display), etc., to display contents of the document created in the above, etc.; and a network coupling section 25, such as a NIC (Network Interface Card), a modem, etc., to couple the computer terminal device 20 to the communication network. In the normal operation, the application programs for creating documents are read form the ROM 21b or the storage device 22 into the RAM 21c so as to execute the application programs concerned.

In this connection, although a personal computer is indicated as the computer terminal device 20 in FIG. 1, any other device, such as, for instance, a PDA (Personal Digital Assistant), a Cellular Phone, etc., can be employed as the computer terminal device 20, as far as the concerned device is capable of creating a document based on a certain standard conformity with the XPS, etc.

Still further, as shown in FIG. 3, the image forming apparatus 30 is constituted by a CPU 31a, a ROM 31b, a RAM 31c, an HDD (Hard Disc Drive) 32, a USB (Universal Serial Bus) interface 33, a LAN interface 34, a display operating section 35, a language analyzing section 36, an image processing section 37, a digital signature analyzing section 38, a printing section 39, etc., all of which are coupled to each other through a bus.

The ROM 31b stores various kinds of programs and data necessary for controlling the overall operations of the image forming apparatus 30 in it. The RAM 31c temporarily stores data to be employed for a controlling operation currently conducted by the CPU 31a and/or other data to be temporarily stored during the controlling operation in it. Accordingly, in conjunction with the ROM 31b and the RAM 31c, the CPU 31a serves as a controlling section (namely, a print controlling section) to control the overall operations of the image forming apparatus 30.

The HDD 32 stores various kinds of the print data, etc., acquired from the computer terminal device 20 in it.

The LAN interface 34 serves as an interface for coupling the image forming apparatus 30 to the communication network, such as a NIC, a modem, etc., so as to receive the print data transmitted from the computer terminal device 20.

The USB interface 33 serves as another interface for coupling various kinds of USB (Universal Serial Bus) devices, such as a USB memory, etc., to the image forming apparatus 30.

The display operating section 35 is constituted by a displaying section, such as an LCD (Liquid Crystal Display), etc., and an operating section, such as a touch panel, etc., so as to display icons, key-buttons and various kinds of settings necessary for the printing operation on the LCD or the like, and to output operational signals inputted from the touch panel or the like.

The language analyzing (or parsing) section 36 analyzes or parses the print data, such as the XPS data, the PDF (Portable Document Format) data, the print data described in the Page Description Language (PDL) being any one of the PS (Post Script), the PCL (Printer Control Language), etc., etc., acquired from the computer terminal device 20 through the LAN interface 34, so as to create new data described in an intermediate format (hereinafter, referred to as intermediate data) to be developed into other data described in a bitmap format (hereinafter, referred to as bitmap data) from the acquired print data. In this connection, hereinafter, the abovementioned processing is referred to as the job analyzing operation. Further, in addition to the above, the language analyzing section 36 extracts a parameter for specifying the printing mode from the print data.

The image processing section 37 creates the bitmap data, serving as printable data, from the intermediate data created by the language analyzing section 36. In this connection, hereinafter, the abovementioned processing is referred to as a bitmap data creating operation.

The digital signature analyzing section 38 analyzes the digital signature attached to the print data. In this connection, hereinafter, the abovementioned processing is referred to as a digital signature analyzing operation. Further, the digital signature of the XPS is conformity with that of the XML, and accordingly, it is possible to attach the digital signature to the XPS data.

According to the printing mode specified by the language analyzing section 36, the printing section 39 prints an image based on the bitmap data created by the image processing section 37. Concretely speaking, in the printing section 39, an exposure section irradiates a light (for instance, a laser beam) modulated according to the bitmap data onto a photoconductor drum uniformly charged with electrostatic charge by a charging device, so as to form a latent image on the photoconductor drum. Successively, a developing device develops the latent image with toner, and the developed toner image is finally transferred onto a paper medium through a primary transfer roller and a secondary transfer belt. Then, a fixing device fixes the toner image onto the paper medium, which is then ejected outside the image forming apparatus 30. Incidentally, the exposure section, the photoconductor drum, the developing device, the primary transfer roller, the secondary transfer belt and the fixing device are included in the printing section 39 and are not shown in the drawings.

In this connection, although each of the language analyzing section 36, the image processing section 37 and the digital signature analyzing section 38 is configured as a hardware structure in the configuration shown in FIG. 3, it is also applicable that at least one of the language analyzing section 36, the image processing section 37 and the digital signature analyzing section 38 is configured as a computer program to be executed in the control section 31 so as to realize its function as software. Further, since the configuration shown in FIG. 3 is merely one of examples of the image forming apparatuses embodied in the present invention, it is also applicable that the USB interface 33, etc. can be excluded from the configuration, and/or a finisher that conducts various kinds of post processing, such as a staple processing, a punch processing, etc., is added to the configuration, as far as the printing operation based on the validity of the digital signature can be implemented according to the parameter established in advance.

As shown in FIG. 4, with respect to the implementation of the printing operation based on the print data, there exists the normal printing operation, in which the CPU 21a of the computer terminal device 20 outputs a print requesting command to the print controller through the printer driver by executing the application program, and the direct printing operation, in which the CPU 21a of the computer terminal device 20 directly outputs the print data to the print controller without executing the application program and without passing through the printer driver. Further, in the printer conformity with the XPS, it is possible to implement the direct printing operation based on the XPS data.

The XPS data is derived by collecting various kinds of files described in the XML form into a single set of data by employing the Zip format, and have a Hierarchy structure in which the Fixed Document Sequence for handling an overall structure and information of the document is positioned at the top hierarchical level, the Fixed Document for handling a page structure and information of its own document is positioned at the second hierarchical level, and the Fixed Page for handling layout information of characters and illustrations residing in the page thereof is positioned at the third hierarchical level.

Further, as shown in FIG. 6, the direct printing operation based on the XPS data having the abovementioned Hierarchy structure is implemented by the control section 31 in the image forming apparatus 30, according to the flowchart including the steps of: receiving the XPS data from the computer terminal device 20; defrosting the XPS data compressed by employing the Zip format (Step S101); spooling the defrosted XPS data into the HDD 32, the RAM 31 c, an external storage device coupled to the image forming apparatus 30 through the USB interface 33, etc., (Step S102); making the language analyzing section 36 read out the XPS data from the HDD 32, etc., (Step S103); creating the intermediate data by conducting the job analyzing operation (Step S104); making the image processing section 37 create the bitmap data based on the intermediate data (Step 8105); and making the printing section 39 conduct the printing operation based on the bitmap data created by the image processing section 37, and then, finalizing the processing.

Still further, it is possible to attach the digital signature to the XPS data. The XPS data attached with the digital signature have such a Hierarchy structure that is shown in FIG. 7, and in which the Signature Part is positioned at the hierarchical level same as that of the Fixed Document Sequence. Quantity of characteristic of the digital signature derived from each element (such as the Fixed Document Sequence, the Fixed Document, the Fixed Page, the Font, the Image) is described in the Signature Part mentioned in the above. Still further, a Print Ticket, in which each of the Fixed Document Sequence, the Fixed Document and the Fixed Page, and print setting information of the Job level, the Document level and the Page level are stored, is also attached to the XPS data. Still further, as shown in FIG. 8, it is also possible in the XPS data to set a Job Digital Signature Processing Keyword for setting the printing mode. The Job Digital Signature Processing Keyword is stored into the Print Ticket, so that any one of three printing modes, including a “Print Invalid Signature” mode in which the print job is implemented irrespective of the validity of the digital signature, a “Print Invalid Signature With Error Report” mode in which the print job is implemented irrespective of the validity of the digital signature, while printing a page for indicating being invalid (hereinafter, referred to as an Error Report), and a “Print Only Valid Signature” mode in which the print job is implemented only when all of the digital signatures are determined as valid, is established corresponding to the Job Digital Signature Processing Keyword currently stored, so as to implement the printing operation according to the established printing mode as indicated in corresponding one of the flowcharts shown in FIGS. 9-11.

For instance, in the “Print Invalid Signature” mode, the direct printing operation, based on the XPS data attached with the digital signature and having the aforementioned Hierarchy structure shown in FIG. 7, is implemented by the control section 31 in the image forming apparatus 30, according to the flowchart, shown in FIG. 9, including the steps of: receiving the XPS data from the computer terminal device 20; defrosting the XPS data compressed by employing the Zip format (Step S201.); spooling the defrosted XPS data into the HDD 32, the RAM 31c, an external storage device coupled to the image forming apparatus 30 through the USB interface 33, etc., (Step S201); reading out the XPS data from the HDD 32, etc., and notifying the digital signature analyzing section 38 of the existence of the readout XPS data (Step S202); making the digital signature analyzing section 38 calculate a quantity of characteristic in respect to each of the elements (Step S203); determining whether or not the calculated quantity of characteristic coincides with that stored in the Signature Part, in respect to each of the elements (Step S204); reading out again the XPS data from the HDD 32, etc., and notifying the language analyzing section 36 of the existence of the readout XPS data (Step S205); making the language analyzing section 36 create the intermediate data by conducting the job analyzing operation (Step S206); making the image processing section 37 create the bitmap data based on the intermediate data (Step S207); and making the printing section 39 conduct the print job based on the bitmap data created by the image processing section 37, and then, finalizing the processing.

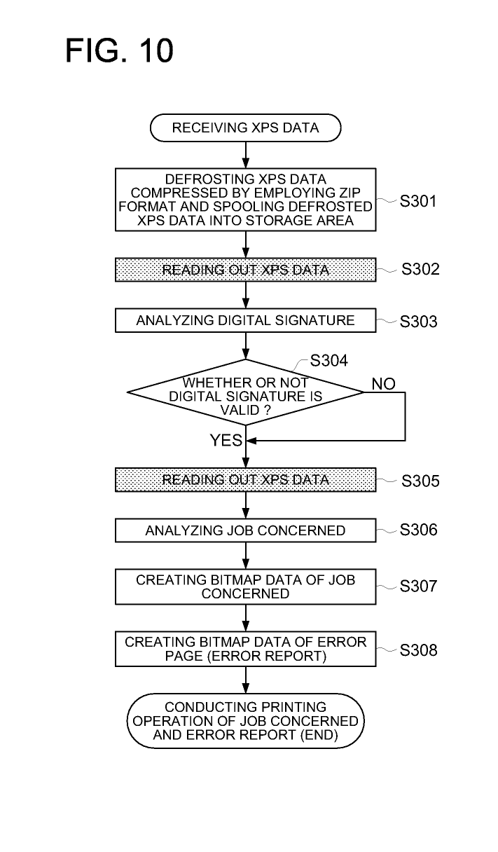

Further, in the “Print Invalid Signature With. Error Report” mode, the direct printing operation, based on the XPS data attached with the digital signature and having the aforementioned Hierarchy structure shown in FIG. 7, is implemented by the control section 31 in the image forming apparatus 30, according to the flowchart, shown in FIG. 10, including the steps of: conducting Steps S301-306 in the same way as Steps S201-206 shown in FIG. 9; making the image processing section 37 create the partial bitmap data based on the partial intermediate data for which the digital signature is determined as valid (Step S307); creating other bitmap data of the Error Report (Step S308); and making the printing section 39 conduct the print job based on the partial bitmap data created by the image processing section 37 and print the Error Report based on the other bitmap data, and then, finalizing the processing.

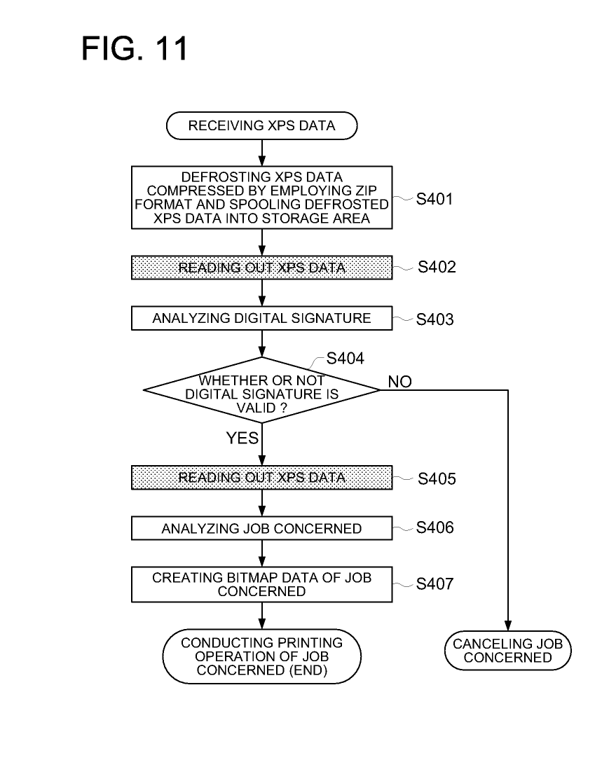

Still further, in the “Print Only Valid Signature” mode, the direct printing operation, based on the XPS data attached with the digital signature and having the aforementioned Hierarchy structure shown in FIG. 7, is implemented by the control section 31 in the image forming apparatus 30, according to the flowchart, shown in FIG. 11, including the steps of: conducting Steps S401-404 in the same way as Steps S201-204 shown in FIG. 9; canceling the print job when determining that digital signature is invalid in Step S404, and then, finalizing the processing; reading out the XPS data from the HDD 32, etc., and notifying the language analyzing section 36 of the existence of the readout XPS data, when determining that digital signature is valid in Step S404 (Step S405); making the language analyzing section 36 create the intermediate data by conducting the job analyzing operation (Step S406); making the image processing section 37 create the bitmap data based on the intermediate data (Step S105); and making the printing section 39 conduct the printing operation based on the bitmap data created by the image processing section 37, and then, finalizing the processing.

As described in the foregoing, when conducting the printing operation in any one of the printing modes of the “Print Invalid Signature” mode, the “Print Invalid Signature With Error Report” mode and the “Print Only Valid Signature” mode, the processing step of reading the spooled XPS data should be conducted twice before the step of analyzing the digital signature and before the other step of analyzing the print job, as shown in FIG. 12(a). Accordingly, when the spooled XPS data are stored in such a storage area that requires a relatively large amount of accessing time, for instance, in the HDD 32, etc., a large amount of time is inevitably consumed for this processing.

To overcome the abovementioned shortcoming, the present embodiment is so constituted that both the digital signature analyzing operation and the print job analyzing operation can be conducted only by reading the spooled XPS data once, so as to shorten the processing time, as shown in FIG. 12(b). Further, on that occasion, it is determined whether or not the digital signature analyzing operation and the job analyzing operation are conducted simultaneously, depending on the printing mode currently established.

Concretely speaking, in the case of the “Print Invalid Signature” mode, since the digital signature is completely ignored, the digital signature analyzing operation is not conducted. While, in the case of the “Print Invalid Signature With Error Report” mode, since the print job should be implemented irrespective of validity of the digital signature, both the digital signature analyzing operation and the job analyzing operation are conducted simultaneously or in parallel. Further, in the case of the “Print Only Valid Signature” mode, since the print job should not be implemented when the digital signature is invalid, if the digital signature analyzing operation and the job analyzing operation were conducted simultaneously the implementation of the job analyzing operation would result in a waste of time in a case where the digital signature is invalid. In order to avoid such the waste of time in the above case, the job analyzing operation is implemented after the digital signature analyzing operation has been completed, without conducting them simultaneously.

FIG. 13 shows a flowchart indicating the abovementioned processing. The flowchart, shown in FIG. 13, to be conducted by the control section 31 in the image forming apparatus 30 includes the steps of: receiving the XPS data from the computer terminal device 20; defrosting the XPS data compressed by employing the Zip format (Step S501); and spooling the defrosted XPS data into the HDD 32, the RAM 3 lc, an external storage device coupled to the image forming apparatus 30 through the USB interface 33, etc., (Step S501). In this connection, it is also applicable that the XPS data are received from a certain data source through the communication network or acquired from the recording medium in which the XPS data are stored.

The flowchart, shown in FIG. 13, further includes the steps of: determining whether or not the digital signature is attached to the XPS data by referring to the Signature Part of the XPS data (Step S502); acquiring the operation setting value as a result of the digital signature analyzing operation from the Print Ticket (namely, acquiring the Job Digital Signature Processing Keyword for specifying the printing mode), when determining that the digital signature is attached in Step S502 (Step S503); specifying the printing mode from the Job Digital Signature Processing Keyword (Step S504); reading out the XPS data from the HDD 32, etc., and notifying both the digital signature analyzing section 38 and the language analyzing section 36 of the existence of the readout XPS data, in the case that the printing operation based on the XPS data concerned should be implemented even if the digital signature is invalid (namely, when the printing mode is specified as either the “Print Invalid Signature” mode or the “Print Invalid Signature With Error Report” mode) (Step S505); making the digital signature analyzing section 38 conduct the digital signature analyzing operation and the language analyzing section 36 create the intermediate data by conducting the job analyzing operation (Step S506); making the digital signature analyzing section 38 determine whether or not the digital signature for each element is valid (Step S507); making the image processing section 37 create the partial bitmap data based on the partial intermediate data only in respect to the element for which the digital signature is valid, when determining that the digital signature for a certain element is invalid (Step S508); creating other bitmap data of the Error Report (Step S509); and making the printing section 39 conduct the print job based on the partial bitmap data in respect to the element for which the digital signature is valid and print the Error Report based on the other bitmap data, and then, finalizing the processing.

On the other hand, the flowchart, shown in FIG. 13, further includes the steps of: making the image processing section 37 create the bitmap data based on the intermediate data in respect to the whole print job, when determining that the digital signatures for all of the elements are valid in Step S507 (Step S510); and making the printing section 39 conduct the printing operation based on the bitmap data created by the image processing section 37, and then, finalizing the processing.

On the other hand, the flowchart, shown in FIG. 13, further includes the steps of: making the image processing section 37 create other bitmap data of the Error Report, when determining that digital signature of each element is invalid (when No in Step S513); and making the printing section 39 print the Error Report based on the other bitmap data, and then, finalizing the processing.

As described in the foregoing, according to the present embodiment, since the control section 31 of the image forming apparatus 30 specifies the printing mode based on the Job Digital Signature Processing Keyword stored in the Print Ticket of the XPS data, and, in the case that the printing mode is set at such a mode that the printing operation should be conducted irrespective of the validity of the digital signature (namely, when the printing mode is specified as either the “Print Invalid Signature” mode or the “Print Invalid Signature With Error Report” mode), the control section 31 controls the digital signature analyzing section 38 and the language analyzing section 36, so as to simultaneously implement both the digital signature analyzing operation to be conducted by the digital signature analyzing section 38 and the print job analyzing operation to be conducted by the language analyzing section 36, it becomes possible to shorten the processing time by reducing the number of operations for reading the spooled XPS data from the HDD 32, etc., resulting in a realization of the high-speed printing operation.

In this connection, although the printing method in regard to the document created on the basis of XPS data has been described in the foregoing, the scope of the present invention is not limited to the embodiment detailed in this specification. It is needless to say that the present invention can be also applied to any other document created by employing another application program, as well.

The present invention can be utilized for: the image forming apparatus that conducts the printing operation based on the print data with the digital signature, which are created by executing the predetermined application program; the printing method to be employed in the network system that includes the abovementioned image forming apparatus; and the control program that is executable in the image forming apparatus concerned.

While the preferred embodiments of the present invention have been described using specific term, such description is for illustrative purpose only, and it is to be understood that changes and variations may be made without departing from the spirit and scope of the appended claims.

1. An image forming apparatus, comprising:
a storage section to store print data acquired from an external environment in it;
a digital signature analyzing section that conducts a digital signature analyzing operation to analyze a digital signature included in the print data;
a language analyzing section that conducts a language analyzing operation to analyze the print data so as to create intermediate data;
an image processing section to create bitmap data from the intermediate data created by the language analyzing section;
a printing section to implement a printing operation based on the bitmap data created by the image processing section; and
a control section that selectively conducts either a first controlling operation or a second controlling operation, wherein, in the first controlling operation, the control section makes the digital signature analyzing section and the language analyzing section respectively conduct the digital signature analyzing operation and the language analyzing operation in parallel, while, in the second controlling operation, the control section makes the digital signature analyzing section conduct the digital signature analyzing operation at first, and makes the language analyzing section conduct the language analyzing operation after the digital signature analyzing operation is completed.

2. The image forming apparatus of claim 1,
wherein, in the first controlling operation, the control section reads out the print data from the storage section and notifies both the digital signature analyzing section and the language analyzing section of existence of the print data, while, in the second controlling operation, the control section reads out the print data from the storage section and notifies the digital signature analyzing section of the existence of the print data at first, and again reads out the print data from the storage section, and notifies the language analyzing section of existence of the print data after the digital signature analyzing operation is completed.

3. The image forming apparatus of claim 1,
wherein the control section conducts the first controlling operation when a first printing mode, in which the printing operation should be conducted irrespective of validity of the digital signature, is established, while the control section conducts the second controlling operation when a second printing mode, in which the printing operation should be conducted only when the digital signature is determined as valid, is established.

4. The image forming apparatus of claim 1,
wherein, when the digital signature is attached to the print data, the control section conducts any one of the first controlling operation and the second controlling operation.

5. The image forming apparatus of claim 1,
wherein the print data are created, based on an XPS (XML Paper Specification).

6. A printing method, comprising:
storing print data acquired from an external environment into a storage section;
conducting a digital signature analyzing operation to analyze a digital signature included in the print data;
conducting a language analyzing operation to analyze the print data so as to create intermediate data;
creating bitmap data from the intermediate data created in the language analyzing operation;
implementing a printing operation based on the bitmap data created in the creating step; and
selecting either a first controlling operation or a second controlling operation, wherein, in the controlling operation, the digital signature analyzing operation and the language analyzing operation are conducted in parallel, while in the second controlling operation, the digital signature analyzing operation is conducted at first, and the language analyzing operation is to be conducted after the digital signature analyzing operation is completed.

7. The printing method of claim 6,
wherein, in the first print controlling operation, the print data are read out from the storage section once before the digital signature analyzing operation and the language analyzing operation are conducted in parallel; and
wherein, in the second print controlling operation, the print data are read out from the storage section before the digital signature analyzing operation is conducted, and then, the print data are read out again from the storage section before the language analyzing operation are conducted.

8. The printing method of claim 6,
wherein both the digital signature analyzing operation and the language analyzing operation are conducted in parallel when a first printing mode, in which the printing operation should be conducted irrespective of validity of the digital signature, is established, while the language analyzing operation is conducted after the digital signature analyzing operation is completed when a second printing mode, in which the printing operation should be conducted only when the digital signature is determined as valid, is established.

9. The printing method of claim 6,
wherein, when the digital signature is attached to the print data, either the first print controlling mode or the second print controlling mode is selected.

10. The printing method of claim 6,
wherein the print data are created, based on an XPS (XML Paper Specification).

11. A computer readable medium storing a computer executable program for processing print data, the program comprising program code for causing a computer, provided in an image forming apparatus, to perform the steps of:
storing the print data acquired from an external environment into a storage section provided in the image forming apparatus;
conducting a digital signature analyzing operation to analyze a digital signature included in the print data;
conducting a language analyzing operation to analyze the print data so as to create intermediate data;
creating bitmap data from the intermediate data created in the language analyzing operation;
implementing a printing operation based on the bitmap data created in the creating step; and
selecting either a first controlling operation or a second controlling operation, wherein, in the first controlling operation, the digital signature analyzing operation and the language analyzing operation are conducted in parallel, while in the second controlling operation, the digital signature analyzing operation is conducted at first, and the language analyzing operation is to be conducted after the digital signature analyzing operation is completed.

12. The computer readable medium of claim 11,
wherein, in the first print controlling operation, the print data are read out from the storage section once before the digital signature analyzing operation and the language analyzing operation are conducted in parallel; and
wherein, in the second controlling operation, the print data are read out from the storage section before the digital signature analyzing operation is conducted, and then, the print data are read out again from the storage section before the language analyzing operation are conducted.

13. The computer readable medium of claim 11,
wherein both the digital signature analyzing operation and the language analyzing operation are conducted in parallel when a first printing mode, in which the printing operation should be conducted irrespective of validity of the digital signature, is established, while the language analyzing operation is conducted after the digital signature analyzing operation is completed when a second printing mode, in which the printing operation should be conducted only when the digital signature is determined as valid, is established.

14. The computer readable medium of claim 11,
wherein, when the digital signature is attached to the print data, either the first controlling operation or the second controlling operation is selected.

15. The computer readable medium of claim 11,
wherein the print data are created, based on an XPS (XML Paper Specification).
